(19) United States
(12) Patent Application Publication
(10) Pub. No.: US 2011/0240438 A1
(43) Pub. Date: Oct. 6, 2011

(54) Arrangement for working workpieces

(76) Inventor: Stephan Pfeil, Steinen (DE)

(21) Appl. No.: 13/065,833

(22) Filed: Mar. 30, 2011

(30) Foreign Application Priority Data
Mar. 31, 2010 (DE) 10 2010 013 506.2

(51) Int. Cl. B65G 47/00

(52) U.S. Cl. 198/339.1

(57) ABSTRACT

In an arrangement for working workpieces, in particular for assembling conductor plates, which arrangement includes at least two workstations which are disposed one after another along a transport path via which the workpieces are normally moved through the arrangement, at least one bypass element is arranged parallel to the normal transport path for allowing the workpieces to bypass at least one of the workstations.

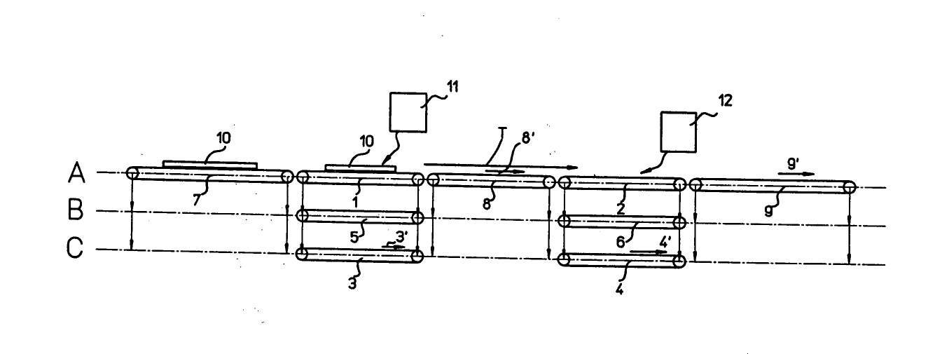

### BACKGROUND OF THE INVENTION

The invention resides in an arrangement for working workpieces, in particular for assembling conductor plates, including at least two work stations into which the workpieces can be moved, the workpieces being arranged one after another on a transport path on which the workpieces are regularly transported through the arrangement.

Such an arrangement is known in the art and is used for example for the assembly of apparatus which have a plurality of individual parts or for the installation of electronic building components on conductor plates.

The transport path on which the workpieces are transported regularly through the apparatus is that path on which the workpieces travel in the apparatus during normal operation of the apparatus from the point of input into the apparatus to the exit point from the apparatus. This is generally a linear path which must be followed.

In each work station for example predetermined individual parts may be mounted onto a base element or respectively predetermined electronic building elements may be applied to a conductor plate. After passing through all the work stations, the device is generally completely assembled, or respectively, the conductor is completed and, if applicable, also soldered.

The transport of the base element or, respectively, the conductor plate through the apparatus is generally accomplished by means of a conveyor belt. Often instead a single correspondingly long conveyer belt a plurality of shorter conveyor belts are used which are arranged one after another in such a way that the base element or respectively, the conductor plate is transferred from one conveyor belt to the next without problem. In this way, a conveyor belt may extend only through a work station and another conveyor belt is used to bridge the space between two work stations. In all known embodiments, the predetermined transport path must be followed.

Instead of providing work stations performing different tasks, the work stations may also perform the same tasks so that workpieces are machined or conductor plates are equipped with components in the work stations in parallel. In this way, the output of the arrangement can be increased.

It is however a disadvantage of such an arrangement that it has only a small error tolerance. A problem occurring for example in one workstation has the result that the respective work piece or conductor plate cannot be further transported, affecting the whole arrangement. For example, if during the installation of components on a conductor plate, only one particular component is missing in a workstation, the whole arrangement stops. Operation can only be resumed when the storage container for the particular component has been replenished.

It is the object of the present invention to design an arrangement or apparatus for machining workpieces in such a way that a greater error tolerance is obtained.

### SUMMARY OF THE INVENTION

In an arrangement for working workpieces, in particular for assembling conductor plates, which arrangement includes at least two workstations which are disposed one after another along a transport path via which the workpieces are normally moved through the arrangement, at least one bypass element is arranged parallel to the normal transport path for allowing the workpieces to bypass at least one of the workstations.

Since in accordance with the invention, a bypass system is provided outside the normal transport path of the workpieces, by way of which the workpieces can bypass at least the first workstation, a particular workpiece can, when necessary, be moved around the first workstation. This means that when an error occurs in the first workstation as a result of which the work cannot be completed in the first workstation so that the workpiece cannot be moved out of the first work station, the subsequent workpiece can bypass the first workstation and supplied to the second workstation bypassing the first workstation. This is particularly expedient if in both workstations the same work is performed on the workpieces. As a result, workpieces can still be processed in the arrangement in spite of a disturbance caused by the first workstation.

Also advantageous is an embodiment of the invention wherein a second bypass element is present outside the normal transport path of the workpiece by way of which the workpieces can be moved past the second workstation. In this way, during a failure in the second workstation as a result of which the workpiece is not fully completed in the second workstation and, consequently, cannot be taken out of the second workstation, a workpiece fully completed in the first workstation can be moved out of the arrangement by bypassing the second workstation.

Particularly advantageous is an embodiment of the invention wherein the transport arrangement of at least the first bypass element is reversible. In this way, a workpiece which could not be properly machined for example in the first workstation can be returned to the entrance of the first workstation and again be supplied to the first workstation for renewed machining or respectively, completion of the assembly.

Advantageously, also the transport direction of the second bypass element is reversible. As a result, the workpiece can be moved out of the second workstation in the normal way and, if necessary, can then be returned to the entrance of the second workstation. The workpiece may also be returned to the entrance of the first workstation via the first bypass element.

In a further, special embodiment of the invention, a first transport element is provided by way of which the workpieces can be supplied at least to the first workstation, as well as an intermediate transport element to which workpieces of the first workstation can be supplied, wherein the first transport element is adjustable in such a way that workpieces can be supplied to the first bypass element and the intermediate transport element is so adjustable that it can accommodate workpieces from the first bypass element.

By way of the transport element consequently workpieces can be supplied to the first work station by way of the normal transport path. This means that the exit of the first transport element is disposed next to the entrance to the first workstation. After adjustment of the first transport element however the exit of the first transport element is disposed next to the entrance of the first bypass element so that a workpiece disposed in the first transport element can be transferred to the first bypass element.

By way of the intermediate transport element, workpieces of the first workstation can be removed via the normal transport path. That is the intermediate transport element is then disposed opposite the exit of the first workstation. After adjustment of the intermediate transport element, the entrance of the intermediate transport element however is disposed opposite the exit of the first bypass element, so that a workpiece disposed in the first bypass element can be transferred to the intermediate transport element.

In accordance with the embodiment of the invention as described above, in a further embodiment of the invention, the second workstation arrangement may be similar. Herein, workpieces can be supplied by way of the intermediate transport element at least to the second workstation. Furthermore, there is at least a third transport element into which workpieces can be directed from the second workstation wherein the intermediate transport element is so adjustable that workpieces can be supplied to the second bypass element and the third transport element is so adjustable that it can accept workpieces from the second bypass element.

Via the intermediate transport element, workpieces can consequently be supplied to the second workstation via the normal transport path. That means that the exit of the intermediate transport element is disposed opposite the entrance of the second workstation. After resetting of the intermediate transport element, the exit of the intermediate transport element however is disposed opposite the entrance of the second bypass element, so that a workpiece present in the intermediate transport element can be transferred to the second bypass element.

In place of a single intermediate transport element, a first partial transport element and a second partial transport element which is separated from the first partial transport element can be arranged between the first workstation and the second workstation. The workpieces then have to be transferred during transfer from the first partial transport element to the second partial transport element.

In a further special embodiment of the invention, there is at least a first buffer element, which is arranged outside the normal travel path of the workpieces and the first transport element is so adjustable that workpieces can be supplied to the first buffer element and the intermediate transport element or respectively the first transport element is so adjustable that it can accept workpieces from the first buffer element.

With the first buffer element, an intermediate storage for workpieces can be provided. This has the advantage that workpieces which have to be returned to the first workstation can be returned already when the first workstation is still occupied by another workpiece. The workpiece to be returned is then first stored in the buffer element. When then the first workstation is again ready to accept a workpiece, the workpiece stored in the buffer element can be supplied to the first workstation. Since the first buffer element may be in close vicinity of the first workstation, little time is needed for supplying the workpiece to the first workstation.

In accordance with the embodiment of the invention just described in a further embodiment of the invention at least a second buffer element is provided which is arranged outside the normal transport path of the workpieces wherein the intermediate transport element or respectively, the second transport element is so adjustable that workpieces can be supplied to the second buffer element and the third transport element is so adjustable that it can accept workpieces from the second buffer element.

In this way, a workpiece which is to be supplied to the second workstation can be stored in the second buffer element in close proximity of the second workstation while the second workstation is still occupied by another workpiece. When the workpiece present in the second workstation leaves the second workstation, the workpiece stored can be rapidly supplied from the buffer element to the second workstation.

In a further particular embodiment of the invention, at least the first workstation as well as at least the first buffer element are adjustable to the track width of the workpieces, in particular the width of the conductor plates and the setting of the track width or respectively the conductor plate width of the first buffer element can be coupled with the adjustment of the track width or respectively the conductor plate width of the first workstation. In this way, workpieces or respectively, conductor plates which have a different track width can be easily processed or respectively equipped in the first workstation. This is especially advantageous if individual workpieces of conductor plates or small series of workpieces are to be processed.

In a similar way, in a further particular embodiment of the invention, at least the second workstation and at least the second buffer element are adjustable to the track width of the workpieces in particular the width of the conductor plates and the adjustment of the track width or respectively the conductor plates of the second buffer element is coupled with the adjustment of the track width or, respectively the conductor plate width of the second workstation. In this way, workpieces can be machined or respectively conductor plates can be assembled also in the second workstation in a simple manner even if they have different track widths or respectively conductor plate widths.

With the arrangement according to the invention, it is on one hand made sure that workpieces can be machined or respectively conductor plates can be assembled even when faults occur in one of the workstations. On the other hand, workpieces of different track width or, respectively conductor plates of different width can be assembled in a simple manner. With the simple adjustment of the track width or respectively conductor plates of different width can be assembled in a simple manner. With the simple adjustment of the track width or respectively the conductor plate width especially also very small runs of workpieces or conductor plates down to single workpieces or respectively conductor plates can be handled.

The invention will become more readily apparent from the following description of an exemplary embodiment with reference to the accompanying drawings.

### BRIEF DESCRIPTION OF THE DRAWINGS

The sole FIGURE shows schematically the arrangement according to the invention.

### DETAILED DESCRIPTION OF A PARTICULAR EMBODIMENT

As apparent from the FIGURE, an arrangement according to the invention includes a first workstation 1 and a second workstation 2. The workstations 1, 2 are shown schematically as conveyor belts, via which conductor plates 10, which are disposed on the conveyor belts, are moved through the workstations. The conductor plates 10 are assembled in the workstations 1, 2 by assembling robots 11, 12. That is, the same electronic building components are installed in the first workstation 1 and also in the second workstation.

In the transport direction T of the conductor plates 10 ahead of the first workstation 1, there is a transport element 7 which is also shown schematically as a transport conveyor belt. In the transport direction T after the first workstation 1 and ahead of the second workstation 2, which is also shown schematically as a transport conveyor belt, an intermediate transport element 8 is arranged which is also shown schematically as a conveyor belt. Furthermore, in the transport direction T after the second workstation 2, a third transport element 9 is arranged which is also shown schematically as a conveyor belt. All transport conveyor belts 1, 2, 7, 8, 9 are arranged in the uppermost plane A of three panes A, B, C.

The intermediate transport element 8 could be replaced by two independently adjustable transport elements. In the same way also the other transport belts could comprise several partial belts. Furthermore, after the third transport element 9 further transport elements as well as additional workstations may be provided.

The first transport element 7 is so designed or arranged that it can be moved from the uppermost plane A to the center plane B or to the lower plane C. In the same way, the intermediate transport element 8 as well as the third transport element 9 are designed or arranged. Also the intermediate transport element 8 and, if present, the partial transport elements as well as the third transport element 9 can be moved to the intermediate plane B or the lower plane C.

Below the first workstation 1, there is in the intermediate plane B a first buffer element 5 which is shown schematically as a conveyor belt. In the same way, a second buffer element 6 which is also shown schematically as a conveyor belt arranged below the second workstation 2 in the intermediate plane B. Below the first buffer element 5, a first bypass element 3 which is also shown schematically as a conveyor belt, is arranged in the lowermost plane C. In the same way, a second bypass element 4, which is also shown schematically as a conveyor belt, is arranged below the second buffer element 6 in the lowermost plane C.

Instead of an arrangement of the elements 1, 2, 3, 4, 5, 6 below one another, they could also be arranged in side-by-side relationship in a direction transverse to the transport direction T next to one another wherein the first transport element 7, the intermediate transport element 8 and the third transport element 9 would be horizontally displaceable.

During normal operation of the arrangement, the conductor plates 10 are supplied at the entrance of the arrangement to the first transport element 7 which transfers the conductor plates 10 to the first workstation 1. In the first workstation 1, electronic components are applied to the conductor plates 10. After the installation of the components the conductor plates 10 are transferred to the intermediate transport element.

From the intermediate transport element 8, the conductor plates 10 are transferred to the second workstation 2. Since the conductor plates 10 were already fully equipped with building components they are transferred, without being worked in the second workstation 2 onto the fourth transport element 9 which transfers the conductor plates 10 at the exit of the arrangement to a subsequent element which is disposed next to the exit of the arrangement but is not shown in the FIGURE.

The transport path T of the conductor plates 10 described earlier corresponds to the transport path along which the workpieces 10 are normally moved through the arrangement. The normal transport path of the conductor plates 10 through the arrangement extends consequently in transport direction T in the uppermost plane A.

If the installation of components on the conductor plates takes the same time in both workstations 1, 2, the conductor plates can be moved through the arrangement with the same rhythm. If the component installation of the conductor plate in the second workstation 2 takes for example longer, because of a disturbance, then the installation of the components of the conductor plate in the first work station 1, the conductor plate in the first workstation 1 after completion can still be moved onto the intermediate transport element 8 so that the first workstation 1 is ready to accept another conductor plate for the installation of components.

As the conductor plate completed in the first work station is now disposed on the intermediate transport element 8, the intermediate transport element 8 is moved to the lowermost plane C. At the same time, the fourth transport element 9 is also lowered to the lowermost plane C. As the intermediate transport element 8 and the fourth transport element 9 are now in the lowermost plane C, the completed conductor plate is transferred from the intermediate transport element 8 to the second bypass element 4 which then transfers the conductor plate directly to the fourth transport element 9.

When the conductor plate is disposed on the fourth transport element 9, the transport element 9 is again moved to the uppermost plane A. Then the completed conductor plate can be taken out of the arrangement. It is therefore possible with the arrangement according to the invention to assemble conductor plates even if in the second workstation a disruption occurs.

If the conductor plates 10 could not be completed in the first workstation 1 because for example particular components to be installed are no longer in store in the installation robot 11 the conductor plates 10 may, after partial completion in the first workstation 1, be transferred to the intermediate transport element 8. From the intermediate transport element 8 the respective conductor plates 10 are transferred to the second workstation 2 where the missing components are then installed. After installation of the remaining components, the conductor plates are then transferred to the third transport element 9 by which they are removed from the arrangement.

Since the installation of the remaining components on the conductor plates 10 in the second workstation occurs in a substantially shorter period than the completion of a bare conductor plate 10 in the first workstation 1 there would be rest period in the second workstation—which would be disadvantageous. Therefore conductor plates 10 can be supplied to the second workstation 2 directly by bypassing the first workstation via the first bypass element 3.

To this end, the first transport element 7 is lowered to the lowermost plane C so that the conductor plate disposed on the first transport element 7 can be transferred to the first bypass element 3. With the lowering of the first transport element 7, the intermediate transport element 8 is also lowered to the lowermost plane C so that the conductor plate 10 can be transferred from the first bypass element 3 onto the intermediate transport element 8.

When he conductor plate 10 is now disposed on the intermediate transport element 8 the intermediate transport element 8 is moved back to the upper plane A so that the conductor plate 10 can be transferred from the intermediate transport element 8 to the second workstation 2. There the components are installed on the conductor plate which, after completion, is transferred to the third transport element 9.

If a conductor plate 10 has to be transferred for completion from the first workstation 1 to the second workstation 2 but the second workstation is not ready to accept the conductor plate 10 since it is still in the process of assembling a conductor plate 10 the incompletely assembled conductor plate of the first workstation 1 can be transferred via the intermediate transport element 8 at first to the second buffer element 6. In this way, the first workstation 1 is in a position to start already the component installation of another workpiece 10.

In the same way as components can be installed on the conductor plate 10 in the second workstation which components could not be installed in the first workstation, components can be installed on the conductor plates in the first workstation which components could not have been installed in the second workstation 2. To this end, the respective conductor plates 10 are transferred from the second workstation 2 for example to the third transport element 9 which then is lowered to the lowermost plane C. Then the respective conductor plate 10 is moved by a reversal of the movement direction 9′ of the third transport element 9 and a reversal of the movement direction 4′ of the second bypass element 4 from the third transport element 9 to the second bypass element 4.

In a corresponding way the respective conductor plate 10 is then carried via the intermediate transport element 8 which was lowered together with the third transport element 9 to the lowermost plane C and the third bypass element 3 to the first transport element 7 from which the conductor plate 10 can then be transferred to the first workstation 1. Obviously, the direction of movement 8′, 3′ of the intermediate transport element 8 and of the first bypass element 3 must also be reversed.

Also during the return of conductor plates to the first workstation 1 a respective conductor plate 10 may be stored in the first buffer element 5, so that the return of the respective conductor plate 10 can already be performed when the first workstation 1 is not yet ready to accept a conductor plate 10.

By means of the arrangement according to the invention, conductor plates can therefore be fully assembled even upon failure of one of the workstations. Since the conductor plates can follow different paths through the arrangement, conductor plates which are incompletely assembled in one workstation can be fully completed in the other workstation. This is advantageous for the output efficiency of the arrangement.

A further improved output efficiency of the arrangement is achieved by the possibility to store conductor plates in the immediate vicinity of the workstations since the conductor plates can already be transported when they cannot yet be accepted by the respective workstation. The remaining travel distance of the conductor plate from the respective buffer element is very short and can be traveled within a short time.

The track widths of the workstations 1, 2 of the transport element 7, 8, 9, of the bypass elements 3, 4 and of the buffer elements 5, 6 are adjustable. In this way, different conductor plates can be assembled in the arrangement in a simple manner. It is therefore possible to handle the assembly of a small series of conductor plates and even single conductor plates in the arrangement according to the invention.

What is claimed is:

1. An arrangement for working workpieces (10), in particular for assembling conductor plates, comprising at least two workstations (1, 2) for receiving the workpieces (10), which stations are disposed one after the other along a transport path via which the workpieces (10) are normally moved through the arrangement, at least one bypass element (3) being arranged outside the normal transport path of the workpieces (10) for allowing the workpieces (10) to bypass at least the first workstation (1).

2. The arrangement according to claim 1, wherein a second bypass element (4) is arranged outside the normal transport path of the workpieces (10) by way of which the workpieces can bypass the second workstation (2).

3. The arrangement according to claim 2, wherein the transport direction (3′, 4′) of at least one of the first bypass element (3) and the second bypass element (4) is reversible.

4. The arrangement according to claim 1, wherein there is provided at least a first transport element (7) for supplying workpieces (10) at least to the first workstation (1) as well as an intermediate transport element (8) to which workpieces can be supplied at least from the first workstation (1), the first transport element (7) being adjustable in such a way that workpieces (10) can be supplied to the first bypass element (3), and the intermediate transport element (8) or respectively, the first transport element (7) being so adjustable that it can accept workpieces (10) from the first bypass element (3).

5. The arrangement according to claim 4, wherein the intermediate transport element (8) comprises separate first and second partial transport elements.

6. The arrangement according to claim 2, wherein workpieces (10) are transferable via the intermediate transport element (8) at least to the second workstation (2) and at least a third transport element (9) is provided to which workpieces (10) can be supplied at least from the second workstation, the intermediate transport element (8) being adjustable for supplying workpieces (10) to the second bypass element (4) and the third transport element (9) being adjustable for accepting workpieces (10) from the second bypass element (4).

7. The arrangement according to claim 1, wherein at least a first buffer element (5) is provided which is arranged outside the normal transport path of the workpieces (10) and the first transport element (7) is adjustable for supplying workpieces (10) to the first buffer element (5) and the intermediate transport element (8) is adjustable for accepting workpieces from the first buffer element (5).

8. The arrangement according to claim 7, wherein a second buffer element (6) is provided which is arranged outside the normal transport path of the workpiece (10) and the intermediate transport element (8) is so adjustable that workpieces (10) can be supplied to the second buffer element (6) and the third transport element (9) is adjustable so that it can accept workpieces from the second buffer element (6).

9. The arrangement according to claim 5, wherein at least the first workstation (1) and at least the first buffer element (5) are adjustable to the track width of the workpieces (10) and the track width adjustment of the first buffer element (5) is coupled with the adjustment of the track width of the first workstation (1).

10. The arrangement according to claim 5, wherein at least the second workstation (2) and at least the second buffer element (6) are adjustable to the track width of the workpieces (10) and the adjustment of the track width of the second buffer element (6) is coupled with the track width adjustment of the second workstation (2).
